(19) United States
(12) Patent Application Publication
(10) Pub. No.: US 2004/0113936 A1
(43) Pub. Date: Jun. 17, 2004

(54) Optimized delivery of multimedia content

(76) Inventor: Kelly L. Dempski, Evanston, IL (US)

Correspondence Address: VEDDER PRICE/ACCENTURE, 222 NORTH LASALLE STREET, CHICAGO, IL, 60601, US

(21) Appl. No.: 10/316,820

(22) Filed: Dec. 11, 2002

(51) Int. Cl. G09G 5/00

(52) U.S. Cl. 345/738

(57) ABSTRACT

In a multi-media distribution system, subscribers make requests for specific content. Content requests of subscribers are collected and analyzed to identify the most important content to deliver. Requested content can be delivered to maximize economic return. Advertising can be embedded and sent to subscribers according to the subject matter requested by the subscribers.

### BACKGROUND

As media consumers demand more control over what they consume and when they consume it, the cost and complexity of systems and equipment required to satisfy those needs will likely rise considerably. and pay-per-view Prior art “video on demand” systems are difficult to implement and costly to operate. Personal video recorders like Tivo™, ^{SM} are inexpensive, but they don't allow a distribution network operator any new service and that have no direct tie-in with the service provider. A better approach is to restructure the backend of a multi-media distribution network in a way that uses existing bandwidth infrastructure more efficiently.

At present, many cable operators offer pay-per-view channels as one form of on demand programming. In such a system, the cable operator will typically stream the same program over several channels on a staggered time schedule. For example, Movie A, which is two hours long, might be shown repeatedly on four different channels with start times staggered at half hour intervals. If a viewer would like to see Movie A, they tune into whichever channel is starting soonest. At most, they have to wait one half hour. In such a pay-per-view system, four channels are used to deliver the same single movie several times over a 24-hour period.

A pay-per-view system that streams the same movie on different channels is an inefficient use of the limited amount of useable spectrum. The same four channels that are used to stream a single movie with different starting times could be used to deliver 48 different, two-hour movies over the same 24-hour period.

Personal Video Recorders (PVRs) such as Tivo create the impression of a custom channel by selectively recording content from the broadcast stream and presenting that content to the user in a repackaged form. It does this by matching broadcast content to a user profile. A given piece of content is recorded when and if it matches the profile. Unfortunately, this system is still limited by the broadcast network. A user must wait until the content is broadcast, and it's possible that it might never be broadcast at all.

A multi-media delivery system should be able to deliver the right content to the right subscriber/user at the right time. Although media delivery system operators attempt to accomplish this by broadcasting many channels with diversified content in hopes that users will find something they like, there is not enough bandwidth available to give users their own custom channels.

A multi-media delivery system that can intelligently distribute or broadcast content based on user demand would be an improvement over the prior art. Such a system should allow the content provider to optimize transmission resources based on demand.

### BRIEF DESCRIPTION OF THE DRAWINGS

FIG. 1 is a diagram of a multi-media distribution network.

FIG. 2 is a depiction of a multi-media content request.

FIG. 3 is a depiction of the organization of a multi-media content request.

FIG. 4 depicts a head end, information it receives and outputs it generates.

FIG. 5 depicts the interaction of the supply/demand scheduler and the transmission scheduler.

FIG. 6 is a flow chart depicting steps of the method of optimizing multi-media distribution.

### DETAILED DESCRIPTION OF A PREFERRED EMBODIMENT

In a preferred embodiment, subscribers to a multi-media distribution network send requests for multi-media programming (referred to herein as “content”) to the distribution network system operator. Content requests can include requests for particular movies, music, serial programming or other forms of multi-media including news, weather, traffic reports, sporting events and music. Content requests are tabulated and used by the distribution network system operator to identify what content to deliver, prioritize how and when to deliver the requested content, and to whom it will be delivered.

A multi-media distribution network can be embodied as a cable television system, a satellite network or a conventional wireless broadcast system using the VHF/UHF or microwave radio spectrum, all of which are equivalent and known to those of ordinary skill in the art. A “content request” can be embodied as a file or data structure, the contents of which comprise a request or “demand” to the multi-media distribution network (and its operator) for the delivery of one or more files that the subscriber wishes to receive.

The delivered content that corresponds to the requested content can be embodied as encrypted or unencrypted data files. They can also be embodied as encrypted or unencrypted analog signals, such as composite video signal or, a RF signal onto which either digital or analog signals are modulated.

In a preferred embodiment, requested content can be identified by indexing stored content files. The process of “indexing” content can be accomplished by tabulating information about a program that can be used to identify the program. The content-identifying information is stored in a data structure or file that can be accessed by a database management program. The database management program searches the index files of content in the library and upon finding an index file that identifies a content file, the database management program can mark the associated content file for selection and distribution.

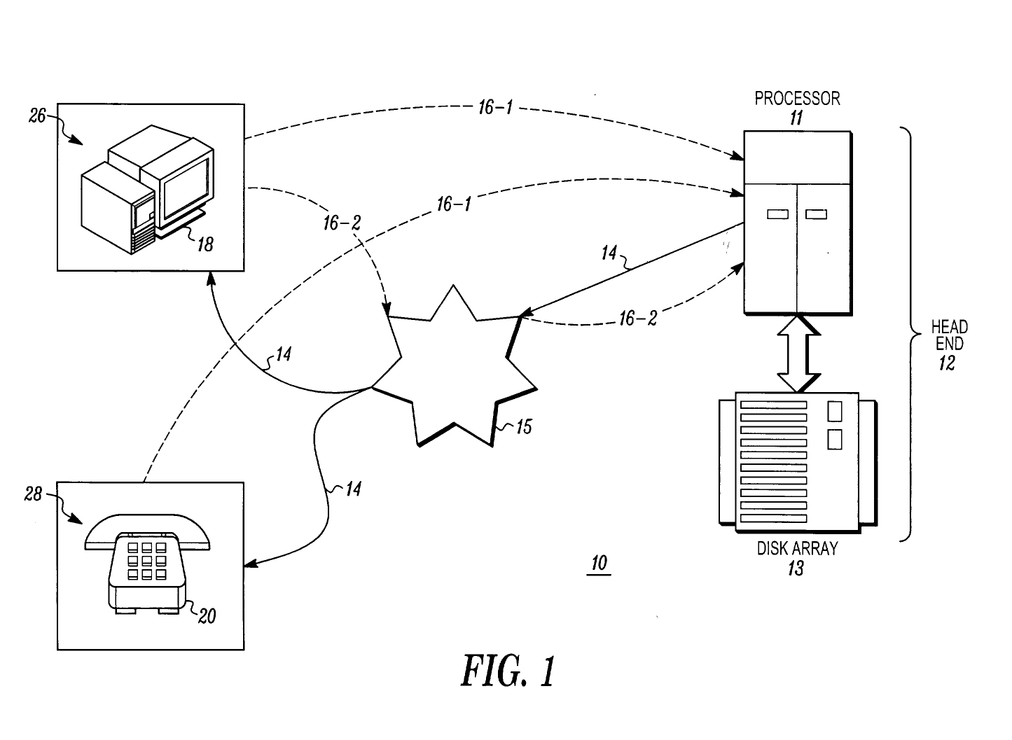

FIG. 1 shows a depiction of elements of a multi-media distribution network 10. The multi-media distribution network has a head-end 12 from which content 14 is distributed to subscribers 18, 20 via a medium such as coaxial cable. In the case of a cable television network, the head end 12 is usually coupled to several distribution nodes (not shown) and from which the coaxial cable is distributed. In the case of a satellite system, reference numeral 12 identifies the satellite from which information is broadcast to earth. The links identified in FIG. 1 by reference numerals 14 and 16 and which couple subscribers 18, 20 to the satellite 12 are radio signals. In the case of a broadcast television station, reference numeral 12 identifies the transmitter and program source. The links identified by reference numeral 14 are radio signals; the links 16-1 and 16-2 can be provided by the public switched telephone network.

The head end 12 is comprised of at least one processor 11 and a disk array 13. The disk array 13 functions as a content storage device or library wherein content for distribution (movies, audio, traffic reports, weather, etc.) is stored. Although a preferred embodiment uses a disk array 13 for content storage, equivalent embodiments use tape and optical disk (e.g., CD-ROM, DVD) for content storage and retrieval.

The processor 11 (or equivalent processors) performs a number of functions. It receives and processes content requests 16-1;16-2 from subscribers 18, 20. The processor 11 retrieves content from the disk array 13 and transmits retrieved content to the subscribers 18, 20 via the network 22. The processor also executes program instructions that perform the functions described more fully below.

As is well-known, in a distribution network such as a cable television system, program content flows downstream from the head end 12 to the subscribers 18, 20. Information also flows upstream from the subscribers 18, 20 to the head end 12 using frequency spectrum that is set aside by the cable television system operator to accommodate upstream communications. Up-stream communications on a cable distribution network is well-known. So-called “pay-per-view” programming is accomplished using upstream communications.

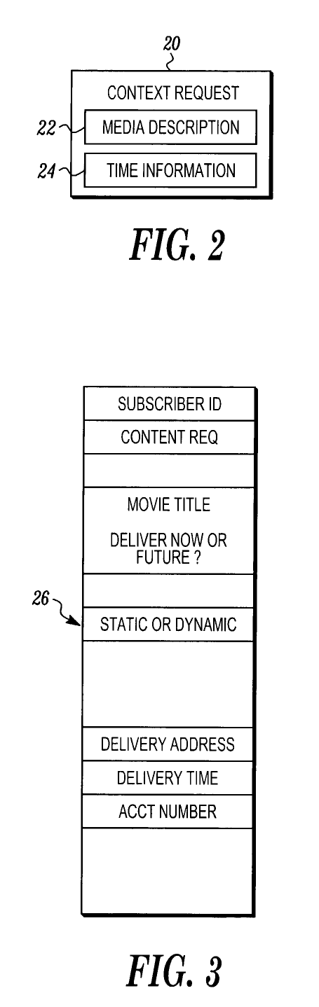

A preferred embodiment of the invention disclosed and claimed herein uses an upstream-directed “content request” message 20 depicted in FIG. 2 and FIG. 3. In a preferred embodiment, a subscriber's content request message 20 is a multi-byte data file or data structure, having two salient pieces of information as shown in FIG. 2. A first information component of a content request message 20 is a media description 22 of the content the user wants. A second component of a content request message 20 is a user-specified delivery time specification 24, which specifies the subscriber'-determined urgency or timeliness. Content request messages 20 can request information such as traffic reports; one or more particular movies at a future time; a movie immediately; a particular episode of a particular program; a sporting event; a sound track or music recording.

FIG. 3 depicts an exemplary arrangement of a content request message 20 having several data bytes. Content requests 20 can be either “static” or “dynamic” as indicated by a request classifier field 26. “Static” demand requests are considered to be continuous or ongoing content requests. Once a static request is issued to the content distributor (either a distribution network operator or a distribution network service provider) the request stays in effect until rescinded or cancelled. An example of a static request would be a request to a network operator to provide all episodes of a particular program, as they are released from a studio or other publisher. A “dynamic” request is a single or one-time request for a particular program, such as a subscriber's request to view a particular movie, sporting event or a particular episode of a serial program.

In a content distribution network 10, subscribers 18, 20 (who are persons who pay for the right to receive content via the network) usually send content request messages at unplanned times and at unplanned intervals. In various embodiments of the invention, content request messages can be sent to the head end 12 a variety of ways.

One way to send a content request message 20 would employ a computer 26 at a subscriber's premises, which can send an upstream content request message 20 to the head end 12 via the distribution network 15. Another way to send a content request message would be via a telephone 28, using DTMF tones. As is known, using voice-over IP telephony, a content request message from a telephone 28 can be sent to the head end 12 via the Internet or the public switched telephone network (not shown for clarity).

Requests can be made for content that is identified by a specific title of a work of authorship or particular program matter. A content request can be made for multi-media (movies or music) of a particular genre or type, or of a particular director or composer. Multi-media requests can be made for content related to a particular subject, such as current events in the news can be requested. Requests can also be made for subject matter from a particular publisher, movie studio or distributor or for a particular program.

Metadata can also be used to request content. Metadata is any attribute that define a range of content. As an example, a subscriber can make a request for movies that include Marlon Brando, where “Marlon Brando” is metadata that identifies certain movies. Upon the receipt of a content request 20, the processor 11 at the head end will collect the request and, after determining that a requested content can be sent, prioritize the requests according to certain criteria.

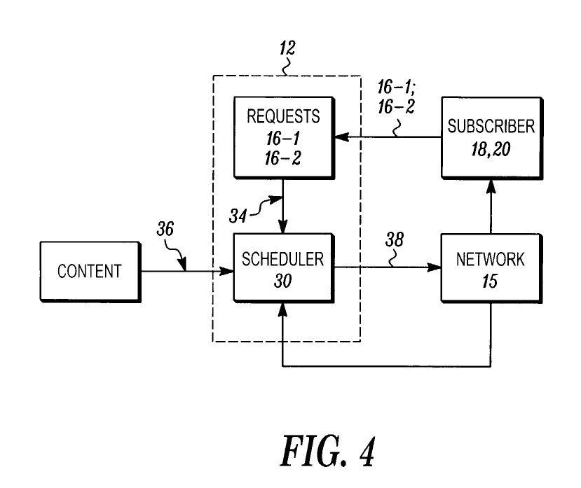

FIG. 4 depicts the head end 12, data or information that is input to the head end in the form of content requests 16-1 and 16-2 and the response of the head end 12 to the content requests. A subscriber 18, 20 sends a content request 16-1 or 16-2 to the head end processor 15 where the content requests are received, parsed and passed to a scheduler 30. The scheduler 30 also receives information from the disk storage array as to the content that is available for delivery 36. Content requests 16-1 and 16-2 are prioritized by the scheduler 30 according to certain criteria and if the requested content 36 is available for delivery, the requested content 38 is broadcast to all of the subscribers via the network 15.

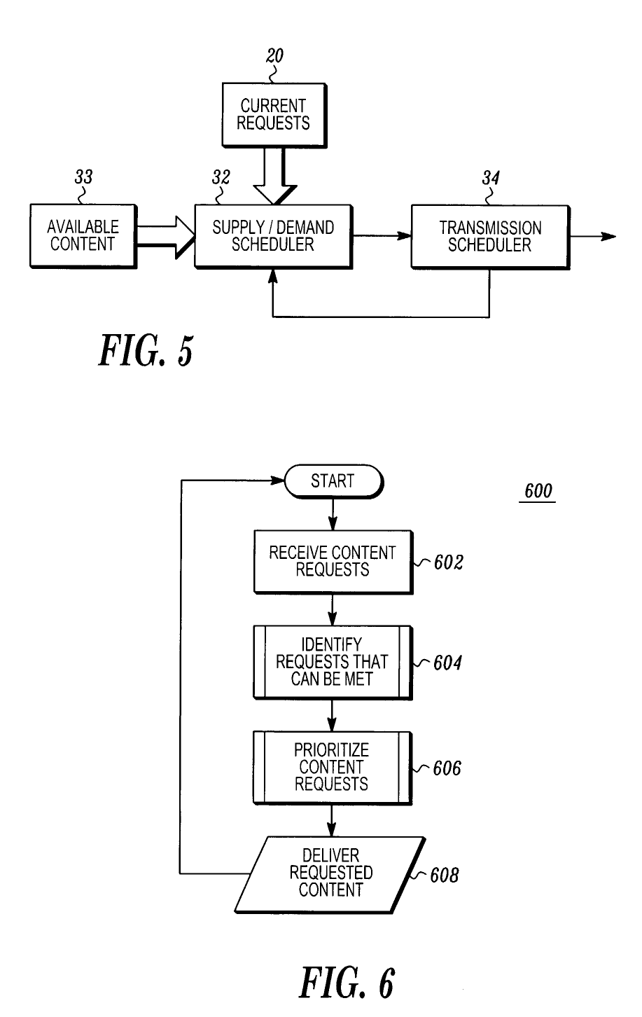

The scheduler 30 is embodied as a computer program. In a preferred embodiment, the scheduler 30 includes both a supply/demand scheduler 32 and a transmission scheduler 34 as depicted in FIG. 5. The supply/demand scheduler 32 and the transmission scheduler 34 cooperatively perform two different functions to optimize the delivery of multi-media content.

Upon receipt of the pending content request 20, the supply/demand scheduler 32 compares the currently available content files 33 stored in the disk array 13 to the current set of demands and determines what content request (or requests) is (are) highest priority, i.e., which content requests 20 should be accommodated. Determining whether a requested multi-media program is available can be accomplished by examining the index files for the content stored in the disk array.

Of the content requests that can be fulfilled, the supply/demand scheduler builds a prioritized list of demands or content requests 20. Using the prioritized list of content requests, the content store 13 is tested by the supply/demand scheduler to determine if requested content is also available content, i.e., determine if a requested content in the library. Determining if a requested content is available can be accomplished by sorting/examining the index files of stored content. If a requested content is available, the transmission scheduler 34 schedules the time of delivery, the medium of delivery and the recipients of the delivery, all via the distribution network 10

The prioritized list can be constructed as a simple, linear list with high-priority items at the top or bottom of the list. It can also be construed as a priority queue, with the requested contents stored in the disk array and awaiting delivery being flagged with different priority levels that determine the order in which the content files will be sent. The prioritized list of demands is used by the transmission scheduler 34 to schedule when to transmit a requested content file onto the network 15.

The delivery of multi-media content is “optimized” by the supply/demand scheduler 32 and the transmission scheduler 34 distributing content that satisfies certain criteria. Criteria that determine whether the supply/demand scheduler 32 and transmission scheduler 34 should affirmatively respond to a content request include whether a requested content is available for delivery (i.e., is it in the disk array 13 or other storage medium and can it be lawfully delivered) and whether the requested content's delivery is of a sufficient economic importance or priority that fulfilling the delivery request is warranted economically.

The importance of fulfilling a content request can be determined by calculating the economic return of fulfilling a content requests. In a pay-per-view service, a subscriber who requests program material pays a fee for each instance that a particular program is requested. A distribution network operator can employ similar revenue collection techniques with the invention disclosed and claimed herein. Content requests to the multi-media distribution network that are satisfied by the network operator can be used to trigger a charge to a customer's account, whether the delivered content is ever viewed by the subscriber. As alternative, content requests that are satisfied and which are viewed after delivery can trigger a charge to a customer's account by requiring a subscriber to request a key to open or decrypt a delivered file. A key to open a delivered file can be delivered by way of a separate request to the network operator. In such a system, content files that are broadcast to all subscribers but which are not wanted by all subscribers will not cause all subscribers to incur an expense for an unwanted program.

By tallying all requests for content from all or substantially all of the subscribers to a network, the network operator can identify the requested contents that will most likely be viewed, and paid for, by the network subscribers. Low yield program requests can be postponed or denied completely in order to delivery more profitable content to the largest number of paying customers.

The economic importance or “priority” of a content request is determined by the supply/demand scheduler 32 considering a number of factors pertinent to the request and its importance. Some factors that determine “priority” include the identity of a subscriber or subscribers making a content request. For instance, a content request from an operator of a chain of hotels with perhaps hundreds of guests warrants a higher priority from a content request from a signal individual. Demographic characteristics (age, income level, gender, race, occupation, citizenship, etc.) of a requesting subscriber can be translated to a high-priority request if the subscribers requesting a particular content are likely to increase or enhance commercial advertising revenue or otherwise benefit the distribution network operator.

In addition to revenue that might be generated by fulfilling a content request, the cost of delivery also affects the priority given to a request. Cost to deliver requested content include at least the transmission time required to download the content (send downstream). Because the amount of spectrum in a multi-media distribution network is limited, delivering lengthy programs means that other programs, which might generate other revenue, might have to wait to be delivered. Cost to deliver requested content can also include royalty payments or license fees by the distribution network operator to distribute the content. Requested content that is relatively costly to deliver is ordinarily of a lower priority than requested content that is relatively inexpensive to deliver.

The number of requests for a particular content will also determine its priority. Large numbers of requests for a particular content can usually be translated into large revenues, if the provision of requested content is conditioned upon payment of a fee for the requested content.

The transmission scheduler optimizes the available distribution network bandwidth resources. Content to be delivered is dynamically assigned to a given “pipe” based on availability. A “pipe” can be one or more program channels over which requested content can be downloaded. A “pipe” can also be one or more channels during a particular time, day of the week or day of the month during which requested content is downloaded. A “pipe” can also be a frequency spectrum of a wireless or satellite distribution network. For instance, a requested movie can be passed from the supply/demand scheduler 32 to the transmission scheduler 34. The transmission scheduler 34 will then determine which “pipe” will be free in order to deliver the movie prior to the time when it was asked to be delivered. By the transmission scheduler 34 knowing that another movie is about to end on channel 46, the transmission scheduler 34 can queues up the new movie on channel 46 for broadcast to the subscribers.

As shown in FIG. 5, the state of the transmission scheduler 34 is also an input to the supply/demand scheduler 32. Information from the transmission scheduler allows the supply/demand scheduler 32 to adjust the priority of content requests based on the status of the transmission scheduler 34 and in turn the distribution network.

For instance, the transmission scheduler 34 might not have capacity for a high priority movie request, but it might have capacity for a lower priority short subject request. The feedback loop from the transmission scheduler 34 to the supply/demand scheduler 32 allows the system to send the low-priority content in a distribution opportunity that might not have another use and which might be wasted.

FIG. 6 depicts the steps of the method 600 for optimizing delivery of multi-media content. In step 602, content requests are received. In step 604, a determination is made that content requests can be satisfied. For the requests that can be satisfied, the requests are prioritized in step 606 as set forth above. Finally, the prioritized requests are delivered in step 608.

In a preferred embodiment, the transmission scheduler 34 forecasts delivery of requested content by either announcing when requested content will be downloaded, or by broadcasting a machine-readable program guide that enables suitably programmed recorders in the subscriber premises to record the content from the network.

Prior art methods such as the “TV Guide”^{SM} provide a near-real-time announcement of upcoming programming by which subscribers can manually record content of interest. A machine-readable program guide embodied as a data stream on one or more program channels can effectively control subscriber recorders to record previously-requested content when the distribution network can most advantageously distributed requested content.

It should be apparent to those of skill in the art that the foregoing system and method enables a multi-media distribution network and service provider to optimize the delivery of multi-media programming to match customer interests. By collecting content requests and identifying the most-important requests to fulfill according to economic return, the delivery of multi-media content can be fine-tuned to maximize revenue while providing better and more responsive service to subscribers.

In addition to satisfying specific subscriber requests, a multi-media distribution network operator or service provider can use content requests to identify other program material that might be of interest to the population of subscribers. Such material might be un-requested and even unknown to subscribers but presented/broadcast nonetheless to stimulate interest and potential income from new and/or untapped program sources.

Those of skill in the art will recognize that knowing what subscribers want to view is of tremendous value to programming sponsors, i.e., advertisers. In addition to enhancing revenue by providing content that subscribers want, potential advertisers can identify demographics of viewers and target their advertising, or provide customized campaigns that will be used more effectively by the inclusion of targeted advertising material with requested content and delivering advertising with the content.

What is claimed is:

1. A method of optimizing the delivery of content to distribution network subscribers via the network, said method comprised of:
receiving a plurality of content requests from at least one subscriber;
prioritizing the content requests for delivery to said at least one subscriber according to a first criteria;
identifying contents that can be delivered;
delivering requested contents to the at least one subscriber via the distribution network according to the first criteria.

2. The method of claim 1 wherein the content requests are at least one of:
a static request for content of particular program matter;
a static request for content of a particular genre;
a static request for content related to particular subject matter;
a static request for content from a particular content provider;
a dynamic request for a particular program.

3. The method of claim 2 wherein a static request is a request for a continuous content delivery.

4. The method of claim 2 wherein a dynamic request is a request for a single content.

5. The method of claim 1 wherein said first criteria is at least one of:
the ability of the network to deliver a requested content;
the availability of a requested content;
the identity of a subscriber requesting a content;
the demographic characteristics of at least one subscriber requesting a content;
the cost of providing a requested content;
the time required to deliver a content via the network;
the number of requests from said plurality of subscribers for a particular content;
a priority of a request for content.

6. The method of claim 1 wherein said first criteria is content file metadata that includes at least one of:
a genre of a requested content file;
a subject depicted in a content file;
a person depicted in a content file;
a title of a content file;
commercial sponsorship depicted in a content file;
a content file creator;
a content file composer.

7. The method of claim 1 wherein the step of delivering requested contents to the at least one subscriber via the network according to the first criteria is further comprised of at least one of:
delivering the requested content via a cable television distribution network;
delivering the requested contents via a satellite system;
delivering the requested content as data via a data network;
delivering the requested content via a wireless distribution network.

8. The method of claim 1 wherein the step of prioritizing content requests for delivery comprises the step of queuing content for delivery at a predetermined time.

9. The method of claim 8 wherein the step queuing content for delivery at a predetermined time includes the steps of:
assigning a plurality of priority levels to requested content, each priority level corresponding to requests received for the contents that are requested;
queuing the requested contents for delivery in a priority queue according to the priority levels assigned to the requested contents.

10. The method of claim 8 wherein the step queuing content for delivery at a predetermined time includes the steps of:
queuing the requested contents for delivery in an order corresponding to the number of requests for a plurality of the requested contents.

11. The method of claim 1 further including the step of:
identifying un-requested content that relates to contents that are requested by said content requests from at least one subscriber;
delivering the un-requested content to at least one subscriber.

12. The method of claim 1 further including the step of:
identifying advertising material for delivery;
delivering the advertising material for delivery to at least one subscriber.

13. The method of claim 1 further including the step of:
identifying targeted advertising, which relates to content that is requested by said content requests;
delivering the targeted advertising for delivery to at least one subscriber.

14. A server for optimizing the delivery of content to distribution network subscribers said server comprised of:
a processor, operatively coupled to, and receiving multi-media content requests from an information distribution network;
program memory, operatively coupled to said processor and storing program instructions for said processor by which said processor prioritizes multi-media content requests according to a first criteria, and by which said processor identifies requested contents that can be delivered and effectuates the delivery of deliverable requested contents to the distribution network according to the first criteria.

15. The server of claim 14 wherein first criteria is at least one of:
the ability of the network to deliver a requested content;
the availability of a requested content;
the identity of a subscriber requesting a content;
the demographic characteristics of at least one subscriber requesting a content;
the cost of providing a requested content;
the time required to deliver a content via the network;
the number of requests from said plurality of subscribers for a particular content;
a priority of a request for content.

16. The server of claim 14 further comprised of:
a multi-media content library storing a plurality of multi-media content files, said multi-media content library being operatively coupled to said processor.

17. The server of claim 15 wherein said multi-media content library is comprised of at least one of:
a magnetic disk storage device;
magnetic tape;
optical disk.

18. The server of claim 14 wherein said information distribution network is at least one of:
a cable television system;
a satellite distribution system;
a wireless communication network;
an Internet Protocol data network;
a synchronous data network.

19. The server of claim 14 wherein the content requests are at least one of:
a static request for content of particular program matter;
a static request for content of a particular genre;
a static request for content related to particular subject matter;
a static request for content from a particular content provider;
a dynamic request for a particular program.

20. The server of claim 14 wherein said processor is comprised of a plurality of distributed processors.

21. A server for optimizing the delivery of content to distribution network subscribers said server comprised of:
a supply/demand scheduler, operatively coupled to a distribution network, said supply/demand scheduler comparing currently available multi-media content files to requests for multi-media content files;
a transmission scheduler, operatively coupled to said supply/demand scheduler and to said distribution network, said transmission scheduler scheduling the usage of the available networking resources and dynamically delivering content to the distribution network;
a content library, operatively coupled to said supply/demand scheduler, said content library storing a plurality of multi-media content files.

22. A terminal for requesting the delivery of a multi-media content file from a distribution network, said subscriber terminal comprised of:
a processor, capable of being operatively coupled to an information distribution network;
a user interface, operatively coupled to and sending commands to said processor;
a multi-media content file storage device operatively coupled to said processor and in which multi-media content files are stored for viewing;
program memory, operatively coupled to said processor and storing program instructions for said processor and by which said processor:
receives from said user interface a request for delivery of a multi-media content file;
formats the request for delivery of a multi-media content file into a message for transmission on said network.

23. The terminal of claim 22 further comprised of:
a processor, capable of being operatively coupled to an information distribution network that is at least one of:
a cable television system;
a satellite distribution system;
a wireless communication network;
an Internet Protocol data network;
a synchronous data network.

24. The terminal of claim 22 wherein said user interface is comprised of at least one of:
a keyboard;
a tactile input pad;
a monitor;
a pointing device.

25. The terminal of claim 22 wherein said multi-media content file storage device is comprised of at least one of:
magnetic disk;
magnetic tape;
semiconductor memory;
optical disk.
